(19) United States
(12) Patent Application Publication
(10) Pub. No.: US 2025/0053416 A1
(43) Pub. Date: Feb. 13, 2025

(54) AUTOMATED SEMANTIC COMPARISON FOR REPRESENTING AN IMPACT BETWEEN DIFFERENT VERSIONS OF A SOFTWARE PACKAGE

(71) Applicant: Dell Products L.P., Round Rock, TX (US)

(72) Inventors: Vinay Sawal, Fremont, CA (US); Ajay Mathur, Hopkinton, MA (US); Vijay Kumar Satyanarayana, Snohomish, WA (US); Ravi Sharma, Chicago, IL (US)

(21) Appl. No.: 18/446,766

(22) Filed: Aug. 9, 2023

(51) Int. Cl. G06F 8/71

(52) U.S. Cl. CPC G06F 8/71

(57) ABSTRACT

Techniques for improved software management in information processing systems are disclosed. For example, an apparatus comprises at least one processing platform comprising at least one processor coupled to at least one memory. The processing platform is configured to obtain a first data set indicative of a first version of a software package and a second data set indicative of a second version of the software package. The processing platform is further configured to perform a semantic comparison of at least a portion of the first data set with at least a portion of the second data set to compute a difference between the first version of the software package and the second version of the software package.

### FIELD

The field relates generally to information processing systems, and more particularly to techniques for managing software in information processing systems.

### BACKGROUND

Product groups of a software enterprise typically release new or upgraded software packages such as, for example, binary software packages, which become available for customers of the software enterprise. A binary software package is a software package already compiled according to an application binary interface (ABI). In other words, a binary software package (i.e., a binary) is an application package with pre-built executable program code (i.e., executables). As such, executables can advantageously be executed on computing platforms with the same ABI, while libraries can advantageously be linked with object files sharing the same ABI.

There is typically some information available in a set of release notes on the extent of change in terms of bug fixes, added features, etc. in the release as compared to the previous release. The process of creating the release notes is largely manual. If the binary contains third party components, e.g., binary large objects (blobs), all information related to what changed may not make it into the final release notes.

Moreover, keeping track of differences between two versions of a released binary that are several versions apart becomes exceedingly difficult due to the incremental nature of the release notes, thus making it challenging with respect to upgrade recommendations to a customer of the enterprise.

### SUMMARY

Illustrative embodiments provide techniques for improved software management in information processing systems. For example, in one embodiment, an apparatus comprises at least one processing platform comprising at least one processor coupled to at least one memory. The processing platform is configured to obtain a first data set indicative of a first version of a software package and a second data set indicative of a second version of the software package. The processing platform is further configured to perform a semantic comparison of at least a portion of the first data set with at least a portion of the second data set to compute a difference between the first version of the software package and the second version of the software package.

In some illustrative embodiments, when performing the semantic comparison of at least a portion of the first data set with at least a portion of the second data set, the processing platform is further configured to represent each component in the software package as a multi-dimensional vector, wherein each dimension of the multi-dimensional vector represents an attribute of the component.

In some illustrative embodiments, when performing the semantic comparison of at least a portion of the first data set with at least a portion of the second data set, the processing platform is further configured to represent the multi-dimensional vectors for the components in the software package as a matrix, wherein one of rows and columns of the matrix represent the components and the other of the rows and columns of the matrix represent attributes of the components.

In some illustrative embodiments, when performing the semantic comparison of at least a portion of the first data set with at least a portion of the second data set, the processing platform is further configured to represent a matrix for the first version of the software package as a first point-cloud and a matrix of the second version of the software package as a second point-cloud.

In some illustrative embodiments, when performing the semantic comparison of at least a portion of the first data set with at least a portion of the second data set, the processing platform is further configured to convert the first point-cloud into a first mesh and the second point-cloud into a second mesh.

In some illustrative embodiments, when performing the semantic comparison of at least a portion of the first data set with at least a portion of the second data set, the processing platform is further configured to compute distances between elements of the first point-cloud and the second mesh and distances between the second point-cloud and the first mesh.

In some illustrative embodiments, when performing the semantic comparison of at least a portion of the first data set with at least a portion of the second data set, the processing platform is further configured to compute an overall objective distance score between the first point-cloud and the second point-cloud based on the computed distances.

In some illustrative embodiments, the processing platform is further configured to generate a scoring data structure wherein the overall objective distance score computed between the first version of the software package and the second version of the software package is stored in the scoring data structure, along with one or more other overall objective distance scores computed between other versions of the software package.

In some illustrative embodiments, when generating the scoring data structure, the at least one processing platform is further configured to use a hyper-parameter threshold value to determine a criticality of an upgrade between versions of the software package.

In some illustrative embodiments, when generating the scoring data structure, the at least one processing platform is further configured to categorize version differences into color-coded bands to reflect the criticality of the upgrade between the versions of the software package.

These and other illustrative embodiments include, without limitation, methods, apparatus, networks, systems, and processor-readable storage media.

### BRIEF DESCRIPTION OF THE DRAWINGS

FIG. 1 illustrates an example of a software package hierarchy with which one or more illustrative embodiments can be implemented.

FIG. 2 illustrates a software package management system environment according to an illustrative embodiment.

FIGS. 3A and 3B illustrate an example of semantic comparison in a software package management system according to an illustrative embodiment.

FIG. 4 illustrates an example of distance scoring in a software package management system according to an illustrative embodiment.

FIG. 5 illustrates an example of a scoring matrix in a software package management system according to an illustrative embodiment.

FIG. 6 illustrates a methodology for software package management according to an illustrative embodiment.

FIGS. 7 and 8 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

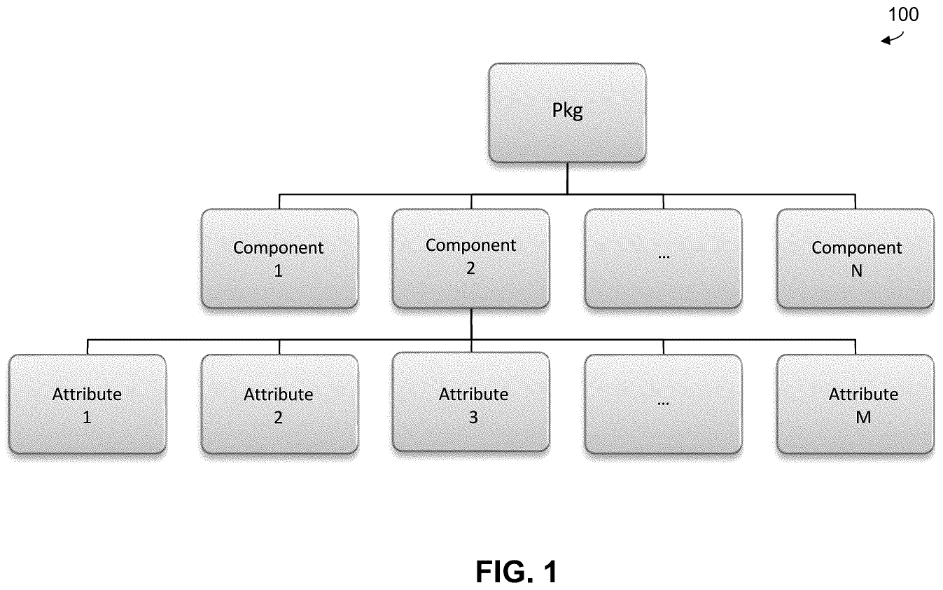

FIG. 1 illustrates an example of a software package hierarchy 100 with which one or more illustrative embodiments can be implemented. More particularly, assume that software package hierarchy 100 represents a software release comprising multiple functional components, i.e., Component 1, Component 2, . . . , Component N, with self-contained features/tasks. Each component may have additional sub-components. Assume further as shown, at a bottom level of software package hierarchy 100, changes associated with each component/sub-component can be captured in the form of attribute categories or attributes, i.e., Attribute 1, Attribute 2, Attribute 3, . . . , Attribute M. Examples of attributes include, but are not limited to, total number of bug fixes, severity of bug fixes, total number of new features, criticality of features, security hot-fix, total lines-of-code, dependency components predecessor, dependency components successor, platforms affected, and reboot requirement. It is realized herein that this set of attributes can form a basis for vectorization of features that can be processed in an automated fashion.

It is to be understood that software package hierarchy 100 is only an example of a hypothetical software package release, e.g., a software binary release. That is, the hierarchical map can be smaller or larger depending on the component type. Each software release may have a different set of attributes based on the business logic the software binary provides. Thus, the example of software package hierarchy 100 is for illustrative purposes only.

As mentioned above, keeping track of differences between two versions of a software package becomes exceedingly difficult, especially when the two versions are several versions apart.

Illustrative embodiments overcome the above and other technical drawbacks with existing software management approaches by providing software package management comprising a semantically meaningful approach that leverages available information from the development process that was used to generate the software package (e.g., binary, image, etc.) to extract meaningful information about the change, extent, magnitude, and/or criticality of the functionality. The extracted information can then be compared using semantic comparison, which identifies semantic differences in the functionality to produce a real-valued score for each pair-wise comparison between two arbitrary software versions. The aggregated output of the overall system can be a scoring matrix that can help a customer understand how far apart the newly released software is compared to the installed version, as well as understand the enterprise's recommendation for the software upgrade based on an upgrade threshold.

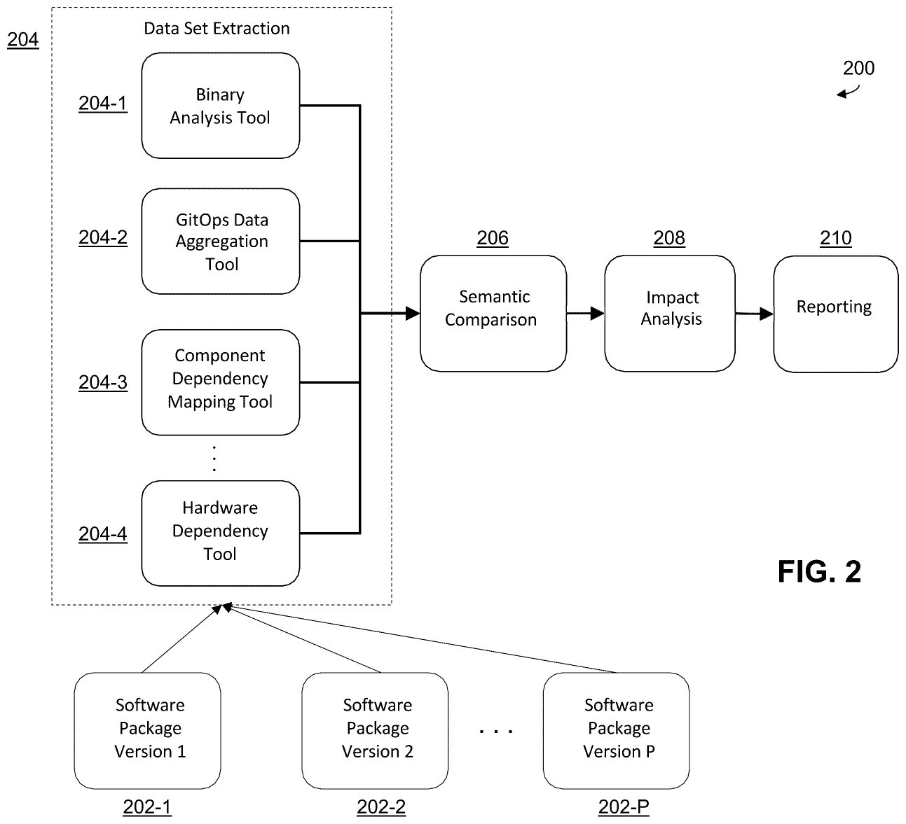

FIG. 2 illustrates a software package management system environment 200 according to an illustrative embodiment. As shown in accordance with modules that are part of software package management system environment 200, a plurality of versions of a software package, i.e., software package version 1 202-1, software package version 2 202-2, . . . , and software package version P 202-P, are operatively coupled to a data set extraction module 204. Data set extraction module 204 comprises a plurality of data collection tools configured to extract or otherwise obtain data indicative of each of software package version 1 202-1, software package version 2 202-2, . . . , and software package version P 202-P.

For example, data collection tools in data set extraction module 204 may comprise a binary analysis tool 204-1, a GitOps data aggregation tool 204-2, a component dependency mapping tool 204-3, and a hardware dependency mapping tool 204-4. In some embodiments, other data collection tools and/or data sources can be part of data set extraction module 204.

As further shown, data set extraction module 204 is operatively coupled to a semantic comparison module 206. Semantic comparison module 206 is operatively coupled to an impact analysis module 208, which is itself operatively coupled to a reporting module 210.

By way of example, binary analysis tool 204-1 can be used for binary blobs in any of software package version 1 202-1, software package version 2 202-2, . . . , and software package version P 202-P. Examples of one or more tools that can be part of binary analysis tool 204-1 include, but are not limited to, disassemblers, de-compilers, and debuggers to reverse engineer the software package versions and extract meaningful information about their features and functionalities.

By way of example, GitOps data aggregation tool 204-2 can collect metrics and other attributes from GitOps tools that contribute towards any of software package version 1 202-1, software package version 2 202-2, . . . , and software package version P 202-P. GitOps is an operational framework that takes best practices used for application development such as version control, collaboration, compliance, and continuous integration and continuous delivery/continuous deployment (CI/CD), and applies them to infrastructure automation. As mentioned above, attributes may include, but are not limited to, bug fixes, new features, security hot fixes, etc.

Still further, component dependency mapping tool 204-3 can collect data indicating how software components of any of software package version 1 202-1, software package version 2 202-2, . . . , and software package version P 202-P depend, if at all, from one another. Similarly, hardware dependency mapping tool 204-4 can collect data indicating hardware dependencies associated with any of software package version 1 202-1, software package version 2 202-2, . . . , and software package version P 202-P.

In one or more illustrative embodiments, semantic comparison module 206 compares the extracted information from any two of software package version 1 202-1, software package version 2 202-2, . . . , and software package version P 202-P to identify semantic differences in their functionalities and architectures. As will be explained in further detail herein, semantic comparison module 206 analyzes the extracted information (data from data set extraction module 204), identifies relevant components/attributes and functions, and compares the structural and feature level differences.

Further, in one or more illustrative embodiments, impact analysis module 208 evaluates the impact of the semantic differences, identified by semantic comparison module 206, on the overall functionality and security of software package version 1 202-1, software package version 2 202-2, . . . , and software package version P 202-P. In some embodiments, impact analysis module 208 simulates the execution of any of software package version 1 202-1, software package version 2 202-2, . . . , and software package version P 202-P under different scenarios and evaluates the differences in behavior and performance.

Still further, in one or more illustrative embodiments, reporting module 210 comprehensively summarizes the semantic differences and their impact on any of software package version 1 202-1, software package version 2 202-2, . . . , and software package version P 202-P. Depending on the business logic, a report generated by reporting module 210 can include a visualization to represent the aggregated difference including a real-valued matrix of scores between every pair-wise software release that can assist a site reliability engineering (SRE) team of the enterprise and/or the end customer with respect to a context-based recommendation on a version upgrade. In some embodiments, reporting module 210 can also allow users to interact with the semantic comparison results and navigate through the different levels of detail, e.g., from high-level architecture to low-level code changes.

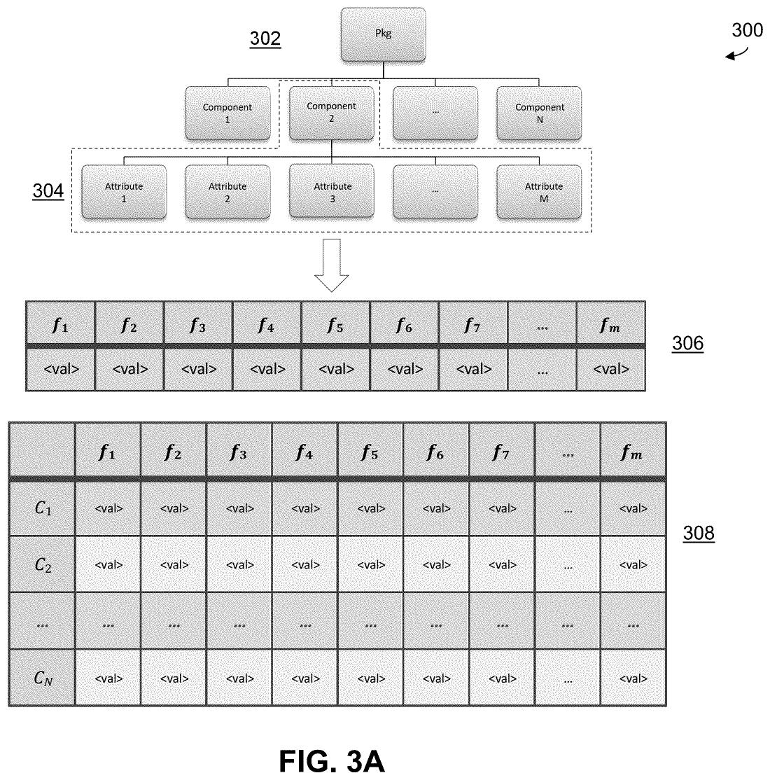

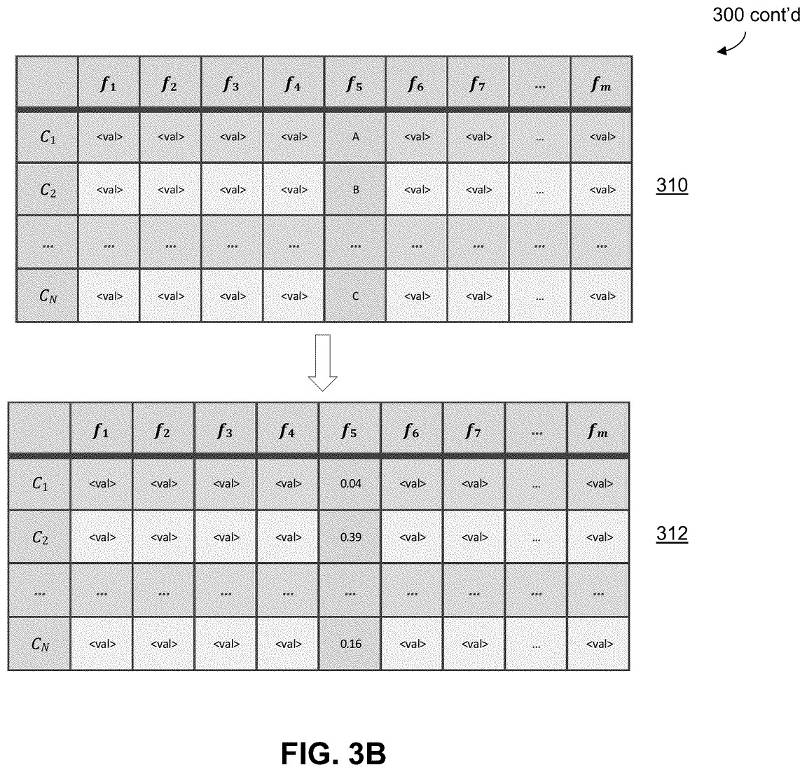

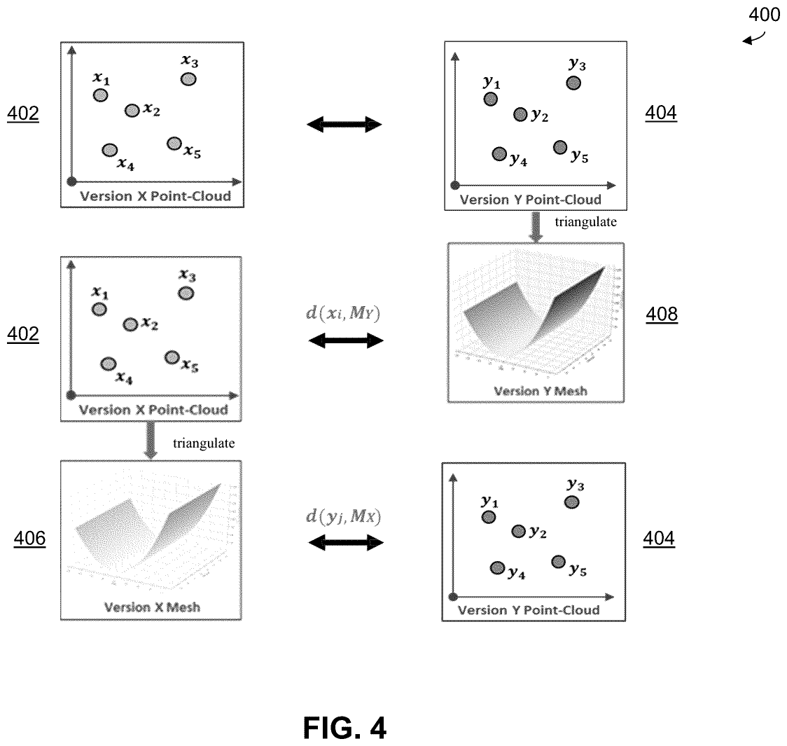

Referring now to FIGS. 3A and 3B, an example 300 of semantic comparison in a software package management system according to an illustrative embodiment is depicted. Note that, in illustrative embodiments, semantic comparison module 206 can perform the steps described herein with regard to FIGS. 3A and 3B (as well as FIG. 4 to be described below). However, in alternative embodiments, one or more other modules in software package management system environment 200 or another information processing system can be configured to perform some or all of the semantic comparison steps.

As mentioned above, a set of attributes for each component of the software package is representable as a vector with m dimensions (an m-dimensional vector). Each attribute is considered a feature in the m-dimensional vector. Thus, as shown in FIG. 3A for a software package 302 with respect to a component 2 and its attributes 1, . . . , M (represented collectively by dashed outline 304), an m-dimensional vector 306 represents attributes 1, . . . , M as features f₁, f₂, f₃, . . . , fₘ.

Since a software package is comprised of n components, feature vectors of all components in the software package can be stacked. Thus, there are a total of n (m-dimensional) vectors, and the vectors are stacked to create an n×m matrix for the software package 302 with components C₁, . . . , C_{N}, as shown in FIG. 3A as a matrix 308. In accordance with illustrative embodiments, as will be further explained below, the component embeddings of matrix 308 can be represented as a point cloud in an n-dimensional space.

In a pre-processing step, in some embodiments, the data in the n×m matrix is transformed before feeding the data to the next stage. For example, categorical (e.g., nominal, ordinal) criteria are converted into numeric features using label encoders and one-hot vector encoders. Data for each criterion is normalized using techniques such as unity-base normalization, linear normalization, vector normalization, etc. Examples of normalization are shown in shown in FIG. 3B as a matrix 310 and a matrix 312.

To generate the semantic comparison value, as illustrated in an example 400 in FIG. 4, illustrative embodiments model the problem as a comparison between two point-clouds where X represents a point-cloud set 402 of components in version x of software package 302:

$$X = ( {x}_{1} , {x}_{2} , {x}_{3} , … {x}_{n} )$$

and Y represents a point-cloud 404 set of components in version y of software package 302:

$$Y = ( {y}_{1} , {y}_{2} , {y}_{3} , … {y}_{m} )$$

One way to perform the semantic comparison is to find a Euclidean distance in n-dimensions between the two point-clouds (denoted as 402 and 404 in FIG. 4). However, Euclidean distance may not cover all cases since the cardinality of these two point-clouds may not be equal.

To solve this issue, illustrative embodiments utilize a method of triangulation to convert the two point-clouds X and Y into two meshes M_{X} and M_{Y} (denoted as 406 and 408 in FIG. 4), respectively, as shown in FIG. 4.

The term d(xᵢ, M_{Y}) represents the distance between elements from point-cloud X(x∈X) and mesh M_{Y}. The objective is to find the shortest distance between every point from set X and mesh M_{Y} as well as the shortest distance between every point from set Y and mesh M_{X}. Once the individual distances are aggregated, an optimal distance between the point-clouds is determined (e.g., optimal here depends on the goal of the software package upgrade but, in one example, can mean a best or at least a sufficient distance that can be used to implement the business logic). In one or more illustrative embodiments, the formula to determine the overall objective difference is:

$$D ( X , Y ) = {\sum }_{i = 1}^{n} min d ( {x}_{i} , {M}_{Y} ) + {\sum }_{j = 1}^{m} min d ( {y}_{j} , {M}_{X} )$$

Thus, advantageously, by applying an optimal distance calculation method, the quantitative distance between the two point-clouds can be determined that represents the difference between the two software versions in a more precise and accurate way than the existing method of manual textual comparison.

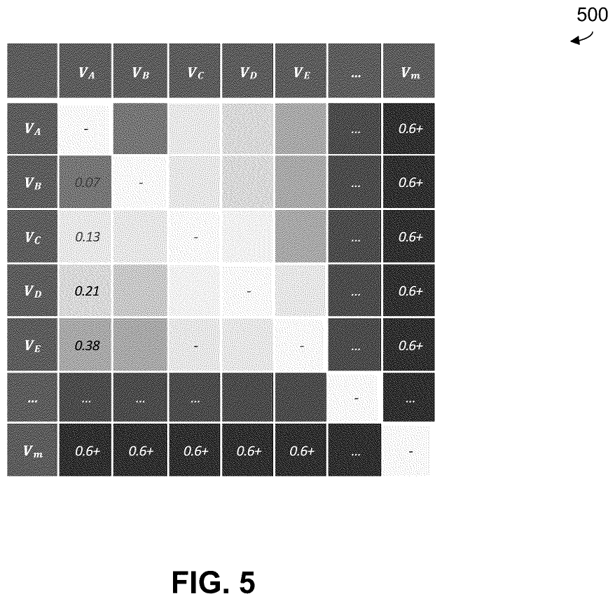

Referring now to FIG. 5, an example 500 of a scoring matrix in a software package management system according to an illustrative embodiment is depicted. The distance scores computed above (e.g., in accordance with the FIG. 4 triangulation method) are run through a normalization step where the distance metrics are normalized to real values between 0 and 1 instead of an arbitrary real value. This helps compare the difference between two sets of versions easier. After normalizing the distances between various versions, a hyper-parameter threshold value based on the business requirement can be used to determine the criticality (i.e., impact) of the upgrade required. Note that, in illustrative embodiments, impact analysis module 208 can perform the steps described herein with regard to FIG. 5. However, in alternative embodiments, one or more other modules in software package management system environment 200 or another information processing system can be configured to perform some or all of the impact analysis steps.

Thus, in one or more illustrative embodiments, a multi-mode classification is utilized to categorize the version difference into color-coded bands of impact or criticality, e.g., an optional upgrade can be represented by green bands, a recommended upgrade can be represented by orange bands, and a mandatory upgrade can be represented by red bands.

For example, as shown in the scoring matrix example 500 in FIG. 5, the distances are stored in the scoring matrix for each pair-wise version. The distance matrix is symmetric across the diagonal. As the version moves further and further away, one can observe a red shift in the difference between the two software versions. As the distance between the two versions widens, the color moves towards red, meaning the need to upgrade to the latest version is at a minimum recommended/justified.

Note that FIG. 5 is presented in grey scale, thus darker grey boxes represent darker red and thus reflect that the upgrade is recommended or critical. For example, for the latest version of the software package, i.e., version Vₘ, indicated in the rightmost column and bottommost row of the scoring matrix, these boxes are darkest grey (deepest red), reflecting that as compared to earlier versions, i.e., versions V_{A} through V_{E}, an upgrade to version Vₘ is mandatory.

It is to be appreciated, however, that illustrative embodiments are not limited to the use of color-coded bands for illustrating upgrade criticality/impact between versions and, thus, alternative techniques for visually reflecting the upgrade criticality/impact between versions are contemplated.

Note that results shown in FIGS. 3A, 3B, 4 and 5, as well as any other results or information used to generate results, can be presented to an entity (e.g., customer, enterprise team, system, etc.) via reporting module 210 of FIG. 2 or some other user interface. The entity can also interact (e.g., provide input, query, etc.) with software package management system environment 200 via reporting module 210 or some other user interface.

Advantageously, illustrative embodiments provide a semantic technique to generate a quantitate comparison value to compare a difference between versions of software by modeling the problem as a comparison between two point-clouds and applying an optimal distance calculation method to determine the difference between the two versions. Among many other benefits, the automated semantic comparison and impact analysis approach according to illustrative embodiments enables the end consumer to visualize the impact and make informed decisions with the various data points.

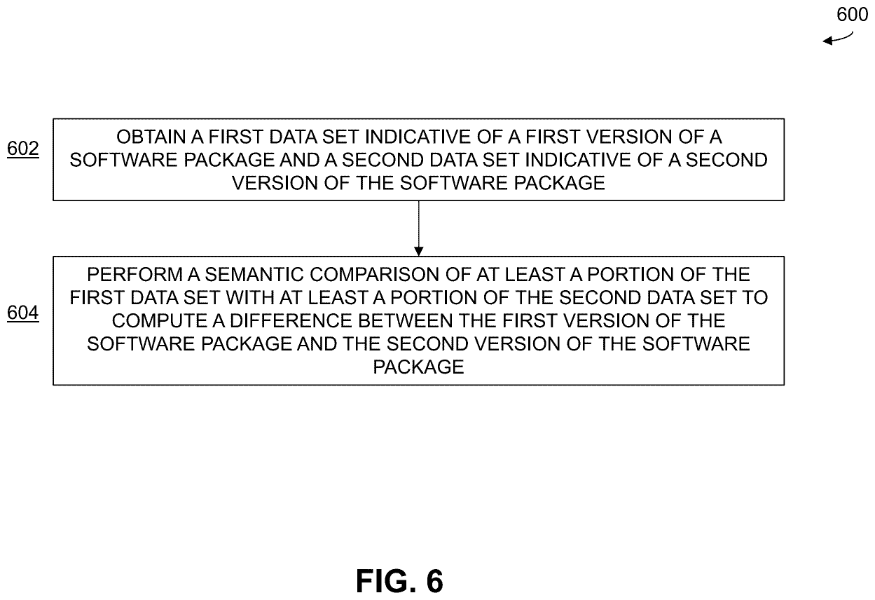

FIG. 6 illustrates a methodology 600 for software package management according to an illustrative embodiment. More particularly, methodology 600 comprises the following steps.

Step 602 obtains a first data set indicative of a first version of a software package and a second data set indicative of a second version of the software package.

Step 604 performs a semantic comparison of at least a portion of the first data set with at least a portion of the second data set to compute a difference between the first version of the software package and the second version of the software package.

In some embodiments of methodology 600, when performing the semantic comparison of at least a portion of the first data set with at least a portion of the second data set, the methodology represents each component in the software package as a multi-dimensional vector, wherein each dimension of the multi-dimensional vector represents an attribute of the component.

In some embodiments of methodology 600, when performing the semantic comparison of at least a portion of the first data set with at least a portion of the second data set, the methodology represents the multi-dimensional vectors for the components in the software package as a matrix, wherein one of rows and columns of the matrix represent the components and the other of the rows and columns of the matrix represent attributes of the components.

In some embodiments of methodology 600, when performing the semantic comparison of at least a portion of the first data set with at least a portion of the second data set, the methodology pre-processes data in the matrix to convert categorical criteria into numeric features and normalize the numeric features.

In some embodiments of methodology 600, when performing the semantic comparison of at least a portion of the first data set with at least a portion of the second data set, the methodology represents a matrix for the first version of the software package as a first point-cloud and a matrix of the second version of the software package as a second point-cloud.

In some embodiments of methodology 600, when performing the semantic comparison of at least a portion of the first data set with at least a portion of the second data set, the methodology converts the first point-cloud into a first mesh and the second point-cloud into a second mesh.

In some embodiments of methodology 600, when performing the semantic comparison of at least a portion of the first data set with at least a portion of the second data set, the methodology computes distances between elements of the first point-cloud and the second mesh and distances between the second point-cloud and the first mesh.

In some embodiments of methodology 600, when performing the semantic comparison of at least a portion of the first data set with at least a portion of the second data set, the methodology computes an overall objective distance score between the first point-cloud and the second point-cloud based on the computed distances. The overall objective distance score represents a difference between the first version of the software package and the second version of the software package.

In some embodiments of methodology 600, the methodology generates a scoring data structure wherein the overall objective distance score computed between the first version of the software package and the second version of the software package is stored in the scoring data structure, along with one or more other overall objective distance scores computed between other versions of the software package.

In some embodiments of methodology 600, when generating the scoring data structure, the methodology normalizes the overall objective distance scores.

In some embodiments of methodology 600, when generating the scoring data structure, the methodology uses a hyper-parameter threshold value to determine a criticality of an upgrade between versions of the software package.

In some embodiments of methodology 600, when generating the scoring data structure, the methodology categorizes version differences into color-coded bands to reflect the criticality of the upgrade between the versions of the software package.

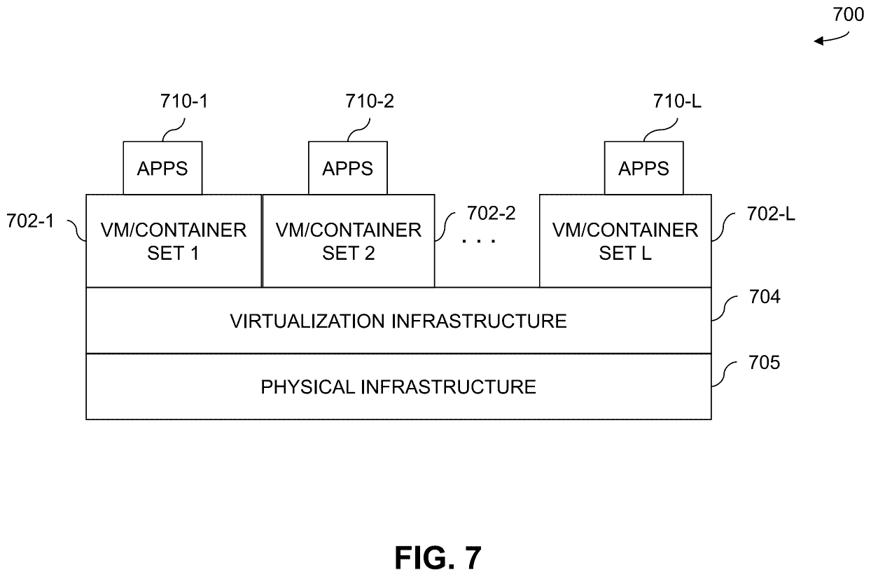

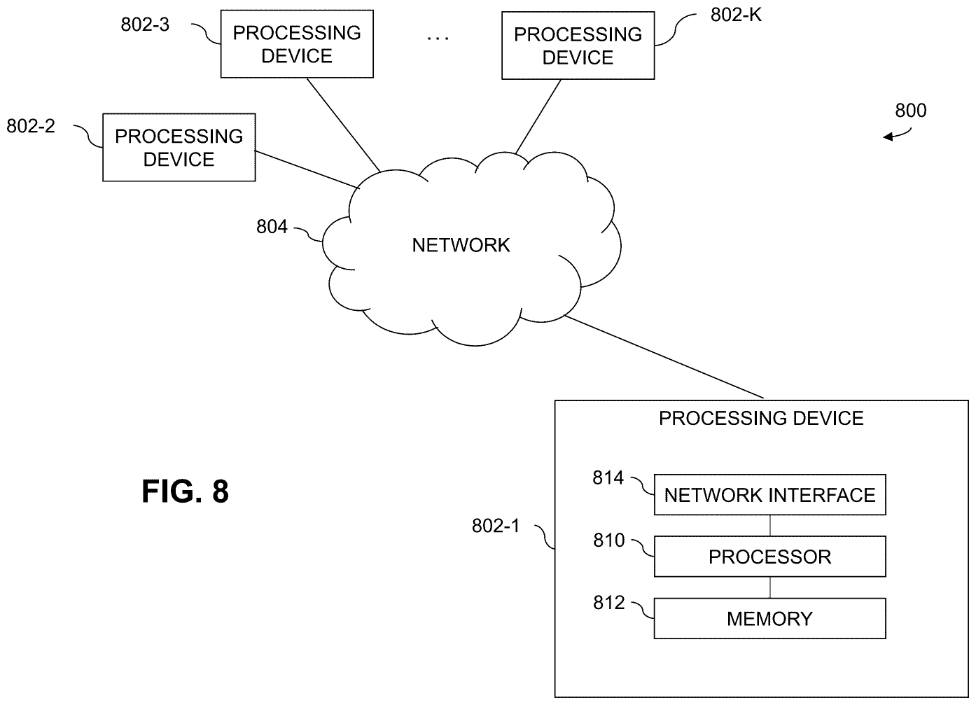

Illustrative embodiments of processing platforms utilized to implement functionality for software package management will now be described in greater detail with reference to FIGS. 7 and 8. Although described in the context of software package management system environment 200, these platforms may also be used to implement at least portions of other information processing systems in other embodiments.

FIG. 7 shows an example processing platform comprising infrastructure 700. Infrastructure 700 comprises a combination of physical and virtual processing resources that may be utilized to implement at least a portion of software package management system environment 200. Infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

Infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of software package management system environment 200 may each run on a computer, server, storage device or other processing platform element. A given such element may be viewed as an example of what is more generally referred to herein as a “processing device.” Infrastructure 700 shown in FIG. 7 may represent at least a portion of one processing platform. Another example of such a processing platform is processing platform 800 shown in FIG. 8.

The processing platform 800 in this embodiment comprises at least a portion of software package management system environment 200 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk, or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and software package management system environment 200 may include additional or alternative processing platforms, as well as numerous distinct processing platforms in any combination, with each such platform comprising one or more computers, servers, storage devices or other processing devices. For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for program code management as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing platform comprising at least one processor coupled to at least one memory, wherein the at least one processing platform is configured to:
obtain a first data set indicative of a first version of a software package and a second data set indicative of a second version of the software package; and
perform a semantic comparison of at least a portion of the first data set with at least a portion of the second data set to compute a difference between the first version of the software package and the second version of the software package.

2. The apparatus of claim 1, wherein, when performing the semantic comparison of at least a portion of the first data set with at least a portion of the second data set, the at least one processing platform is further configured to represent each component in the software package as a multi-dimensional vector, wherein each dimension of the multi-dimensional vector represents an attribute of the component.

3. The apparatus of claim 2, wherein, when performing the semantic comparison of at least a portion of the first data set with at least a portion of the second data set, the at least one processing platform is further configured to represent the multi-dimensional vectors for the components in the software package as a matrix, wherein one of rows and columns of the matrix represent the components and the other of the rows and columns of the matrix represent attributes of the components.

4. The apparatus of claim 3, wherein, when performing the semantic comparison of at least a portion of the first data set with at least a portion of the second data set, the at least one processing platform is further configured to pre-process data in the matrix to convert categorical criteria into numeric features and normalize the numeric features.

5. The apparatus of claim 3, wherein, when performing the semantic comparison of at least a portion of the first data set with at least a portion of the second data set, the at least one processing platform is further configured to represent a matrix for the first version of the software package as a first point-cloud and a matrix of the second version of the software package as a second point-cloud.

6. The apparatus of claim 5, wherein, when performing the semantic comparison of at least a portion of the first data set with at least a portion of the second data set, the at least one processing platform is further configured to convert the first point-cloud into a first mesh and the second point-cloud into a second mesh.

7. The apparatus of claim 6, wherein, when performing the semantic comparison of at least a portion of the first data set with at least a portion of the second data set, the at least one processing platform is further configured to compute distances between elements of the first point-cloud and the second mesh and distances between the second point-cloud and the first mesh.

8. The apparatus of claim 7, wherein, when performing the semantic comparison of at least a portion of the first data set with at least a portion of the second data set, the at least one processing platform is further configured to compute an overall objective distance score between the first point-cloud and the second point-cloud based on the computed distances.

9. The apparatus of claim 8, wherein the overall objective distance score represents a difference between the first version of the software package and the second version of the software package.

10. The apparatus of claim 9, wherein the at least one processing platform is further configured to generate a scoring data structure wherein the overall objective distance score computed between the first version of the software package and the second version of the software package is stored in the scoring data structure.

11. The apparatus of claim 10, wherein one or more other overall objective distance scores computed between other versions of the software package are stored in the scoring data structure.

12. The apparatus of claim 11, wherein, when generating the scoring data structure, the at least one processing platform is further configured to normalize the overall objective distance scores.

13. The apparatus of claim 12, wherein, when generating the scoring data structure, the at least one processing platform is further configured to use a hyper-parameter threshold value to determine a criticality of an upgrade between versions of the software package.

14. The apparatus of claim 13, wherein, when generating the scoring data structure, the at least one processing platform is further configured to categorize version differences into color-coded bands to reflect the criticality of the upgrade between the versions of the software package.

15. A computer program product comprising a non-transitory processor-readable storage medium having stored therein one or more software programs wherein, when executed by at least one processing device, causes the at least one processing device to:
obtain a first data set indicative of a first version of a software package and a second data set indicative of a second version of the software package; and
perform a semantic comparison of at least a portion of the first data set with at least a portion of the second data set to compute a difference between the first version of the software package and the second version of the software package.

16. The computer program product of claim 15, wherein, when performing the semantic comparison of at least a portion of the first data set with at least a portion of the second data set, the one or more software programs, when executed by the at least one processing device, further causes the at least one processing device to perform a distance score calculation process to compute the difference between the first version of the software package and the second version of the software package.

17. The computer program product of claim 16, wherein the one or more software programs, when executed by the at least one processing device, further causes the at least one processing device to generate a scoring data structure, wherein a distance score computed between the first version of the software package and the second version of the software package is stored in the scoring data structure along with one or more other distance scores computed between other versions of the software package.

18. A method comprising:
obtaining a first data set indicative of a first version of a software package and a second data set indicative of a second version of the software package; and
performing a semantic comparison of at least a portion of the first data set with at least a portion of the second data set to compute a difference between the first version of the software package and the second version of the software package;
wherein the steps are performed by at least one processing platform comprising at least one processor coupled to at least one memory.

19. The method of claim 18, wherein performing the semantic comparison of at least a portion of the first data set with at least a portion of the second data set further comprises performing a distance score calculation process to compute the difference between the first version of the software package and the second version of the software package.

20. The method of claim 19, further comprising generating a scoring data structure, wherein a distance score computed between the first version of the software package and the second version of the software package is stored in the scoring data structure along with one or more other distance scores computed between other versions of the software package.
